(19) United States
(12) Patent Application Publication
(10) Pub. No.: US 2018/0293550 A1
(43) Pub. Date: Oct. 11, 2018

(54) COGNITIVE ENHANCEMENT TO MEETING SCHEDULING

(71) Applicant: INTERNATIONAL BUSINESS MACHINES CORPORATION, Armonk, NY (US)

(72) Inventors: Qian Liang, Beijing (CN); Che Pan, Beijing (CN); Zhiyu Yue, Westford, MA (US)

(21) Appl. No.: 15/704,241

(22) Filed: Sep. 14, 2017

Related U.S. Application Data
(63) Continuation of application No. 15/483,129, filed on Apr. 10, 2017.

(51) Int. Cl. G06Q 10/10

(52) U.S. Cl. CPC G06Q 10/1095

(57) ABSTRACT

A method and system for scheduling a calendar meeting includes initiating a meeting request by a meeting chairperson having a calendar application. The meeting request includes a plurality of invitees and a meeting description. Availability of the invitees is detected and retrieved by determining a calendar availability for each of the invitees. The availability of the invitees is analyzed in relation to the meeting description to determine a list of available invitees. The method and system determine an importance of a scheduled meeting in an invitee's calendar in response to a calendar conflict between the meeting request and another scheduled meeting on the invitee's calendar. The importance is determined using a cognitive analysis of the invitee's calendar entry and the meeting description. The cognitive analysis includes determining an available invitee with a calendar conflict, and determining the importance of the invitee to the scheduled meeting using the cognitive analysis.

### BACKGROUND

The present disclosure relates to enhanced meeting scheduling using a software application, such as a calendar application. More specifically, the present disclosure relates to enhanced meeting scheduling using a software application which uses cognitive analysis to determine and advise efficient meeting scheduling.

Scheduling meetings using a software application, for example, a calendar application, is commonly used to schedule a meeting between multiple invitees. A user initiating a meeting or meeting request can use a calendar application to find a suitable time for invitees to attend their proposed meeting. Some current calendar applications provide the capability to suggest a meeting time based on one or more invitees' listed calendar availability. In some instances, invitees are not available, or one invitee of a group of invitees is not available. The process of finding an available time and/or day for a meeting of multiple invitees can be an iterative process of trial and error, and contact (e.g., back and forth) between the initiator of the meeting and invitees. Current calendar systems, for example, a shared calendar by employees in the same company, will show an invitee's availability to meet but will not provide context as to why a person cannot meet unless the invitee manually enters this information. The process of finding availability of invitees and re-scheduling meeting times to accommodate invitees can be challenging, and may take significant time and manual effort on the part of the user initiating the meeting.

### SUMMARY

In one example, a user using a calendar scheduling application on a computer can initiate a meeting only to find that the invitees and the initiating user cannot find a common time available. In one example, the initiating user can suggest times and days for a meeting and ask invitees to find a common available date and time. This can be time consuming, requiring back and forth between the initiating user and the invitees, and still may not result in a common available day and time for a meeting. Such an approach can be inefficient and time consuming.

It can be difficult to determine a person's (e.g., an invitee's) true availability in a shared calendar application, such as employees in the same company. Some entries on a person's calendar can be for informational purposes, and some entries can be important or crucial, and other entries may be social. However, all these entries will occupy a person's calendar, which can make scheduling a meeting with multiple invitees difficult because the time slots on particular days show as occupied on the calendar. Thus, what is needed is a process for determining the value or importance of the calendar entries on invitees' calendars.

The present invention provides a method and system for an initiating user inviting multiple invitees to a meeting to find an available day and time for invitees to attend a proposed meeting. In one example, an available time can be arranged by identifying non-essential invitees and designating those invitees as optional. In another example, a non-essential meeting can be identified in an invitee's calendar and changed to optional.

In an aspect according to the invention, a method for scheduling a calendar meeting includes initiating a meeting request by a meeting chairperson using a computer having a calendar application. The meeting request includes a plurality of invitees and a meeting description. The meeting request can be sent to a plurality of invitees. The method includes detecting and retrieving availability of the invitees by determining a calendar availability for each of the invitees. The method includes analyzing the availability of the invitees in relation to the meeting request to determine an available invitee with no calendar conflicts. An importance of a scheduled meeting is determined in each of an invitee's calendars in response to a calendar conflict for scheduling a common meeting day and time between the invitees. A calendar conflict exits where there is no common meeting day and time between the invitees based on the scheduled meetings in their calendars. The importance is determined using a cognitive analysis of the invitees' calendar entries. The cognitive analysis includes a meeting description, invitee scheduled meeting information, (also referred to as calendar entry information) and a profile of the invitee having historical data of a past related meeting to the meeting request. The method includes determining an available invitee with a calendar conflict for the meeting request based on the analyzing of the availability of the invitees. The available invitee is marked as such based on the cognitive analysis determining that the meeting description of the meeting request is more important than the scheduled meetings in the invitee's calendar. The method includes presenting the meeting chair with a list of the available invitees with a common meeting day and time for the meeting request.

In another aspect according to the present invention, a system schedules a calendar meeting. The system comprises a computer system comprising: a computer processor, a computer-readable storage medium, and program instructions stored on the computer-readable storage medium being executable by the processor, to cause the computer system to perform a method. The system comprises includes initiating a meeting request by a meeting chairperson using a computer having a calendar application. The meeting request includes a plurality of invitees and a meeting description. The meeting request can be sent to a plurality of invitees. The system includes detecting and retrieving availability of the invitees by determining a calendar availability for each of the invitees. The system includes analyzing the availability of the invitees in relation to the meeting request to determine an available invitee with no calendar conflicts. An importance of a scheduled meeting is determined in each of an invitee's calendars in response to a calendar conflict for scheduling a common meeting day and time between the invitees. A calendar conflict exits where there is no common meeting day and time between the invitees based on the scheduled meetings in their calendars. The importance is determined using a cognitive analysis of the invitees' calendar entries. The cognitive analysis includes a meeting description, invitee scheduled meeting information, (also referred to as calendar entry information) and a profile of the invitee having historical data of a past related meeting to the meeting request. The system includes determining an available invitee with a calendar conflict for the meeting request based on the analyzing of the availability of the invitees. The available invitee is marked as such based on the cognitive analysis determining that the meeting description of the meeting request is more important than the scheduled meetings in the invitee's calendar. The system includes presenting the meeting chair with a list of the available invitees with a common meeting day and time for the meeting request.

In another aspect according to the present invention, a computer program product schedules a calendar meeting in a computer networked environment. The computer program product comprises a computer readable storage medium having program instructions embodied therewith. The computer readable storage medium is not a transitory signal per se, and the program instructions are executable by a computer to cause the computer to perform a method. The computer program product includes initiating a meeting request by a meeting chairperson using a computer having a calendar application. The meeting request includes a plurality of invitees and a meeting description. The meeting request can be sent to a plurality of invitees. The computer program product includes detecting and retrieving availability of the invitees by determining a calendar availability for each of the invitees. The computer program product includes analyzing the availability of the invitees in relation to the meeting request to determine an available invitee with no calendar conflicts. An importance of a scheduled meeting is determined in each of an invitee's calendars in response to a calendar conflict for scheduling a common meeting day and time between the invitees. A calendar conflict exits where there is no common meeting day and time between the invitees based on the scheduled meetings in their calendars. The importance is determined using a cognitive analysis of the invitees' calendar entries. The cognitive analysis includes a meeting description, invitee scheduled meeting information, (also referred to as calendar entry information) and a profile of the invitee having historical data of a past related meeting to the meeting request. The computer program product includes determining an available invitee with a calendar conflict for the meeting request based on the analyzing of the availability of the invitees. The available invitee is marked as such based on the cognitive analysis determining that the meeting description of the meeting request is more important than the scheduled meetings in the invitee's calendar. The computer program product includes presenting the meeting chair with a list of the available invitees with a common meeting day and time for the meeting request.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a schematic block diagram illustrating an overview of a system and methodology for using cognitive analysis to schedule a meeting between parties in a computer networked environment.

FIG. 2 is a flow chart illustrating a method for scheduling a meeting using cognitive analysis based on the system shown in FIG. 1, according to an embodiment of the disclosure.

FIG. 3 is a flow chart continuing from the flow chart shown in FIG. 2, depicting additional steps according to an embodiment of the method shown in FIG. 2.

FIG. 4 is a flow chart continuing from the flow chart shown in FIG. 2, illustrating another embodiment according to the method shown in FIG. 2, where an invitee profile assigns a priority to a current meeting based on historical data contained in an invitee profile.

FIG. 5 is a schematic block diagram depicting a computer system according to an embodiment of the disclosure which includes a detailed depiction of a computer (shown generally in FIG. 1), and which cooperates with the system and methods shown in FIGS. 1, 2, and 3.

FIG. 6 is a flow chart illustrating a method according to an embodiment of the disclosure, for scheduling a meeting using cognitive analysis based on the system shown in FIG. 1.

FIG. 7 is a flow chart depicting an alternative initiation for the flow chart shown in FIG. 6 where a meeting chair initiates a meeting request with a date and/or time range.

FIG. 8 is a schematic block diagram depicting a computer system according to an embodiment of the disclosure which includes a detailed depiction of a computer (shown generally in FIG. 1), and which cooperates with the system and methods shown in FIGS. 1, 2, and 3, 4, and 5.

FIG. 9 depicts a cloud computing environment according to an embodiment of the present invention.

FIG. 10 depicts abstraction model layers according to an embodiment of the present invention.

### DETAILED DESCRIPTION

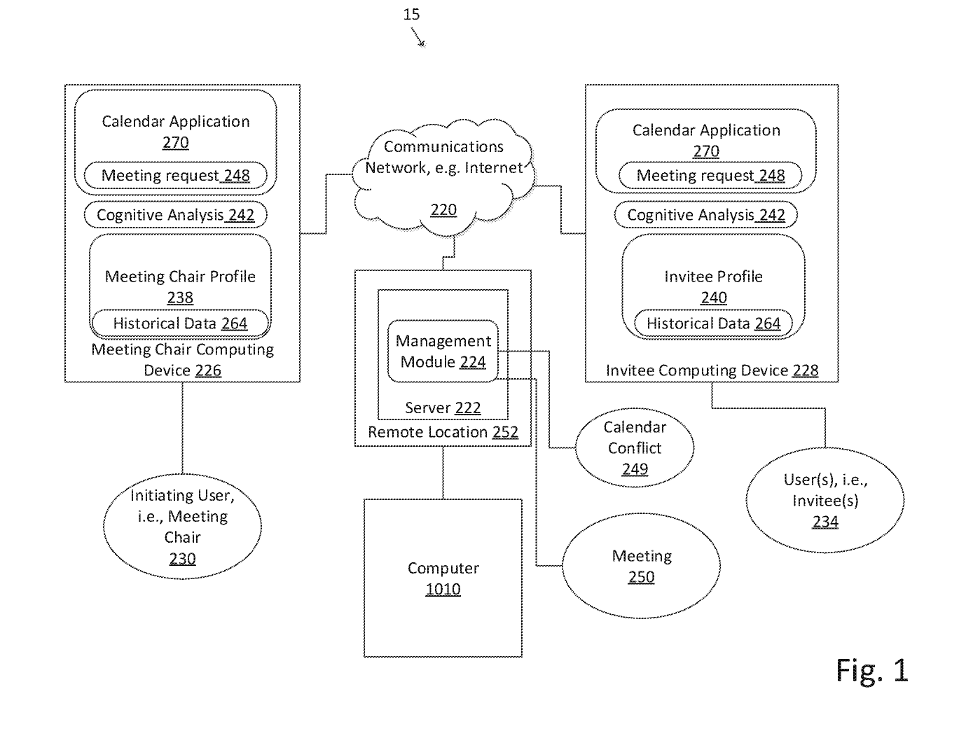

With reference to FIGS. 1, 2, 3 and 4, in one embodiment according to the present invention, a system 15, and a method 100 with reference to the system 15, are shown for scheduling a meeting using a cognitive analysis 242. For example, an initiating user 230 using a meeting chair computing device 226 having a calendar application 270 can send a meeting request 248 to one or more invitees 234 using an invitee computing device 228 and having the calendar application 270. The initiating user 230 is also referred to as the meeting chair, meeting chairperson, or as the user sending the meeting invitation. It is understood that the meeting chairperson can be included as an invitee for the purposes of ascertaining a calendar conflict. The cognitive analysis 242 uses natural language processing to compare calendar entries in an invitee's 234, calendar application 270 in order to schedule a meeting 250. The cognitive analysis 242, meeting chair profile 238, invitee profile 240 and calendar application can be placed in a local location i.e. meeting chair computing device 226, or a central location e.g., on a server 222 or a remote server.

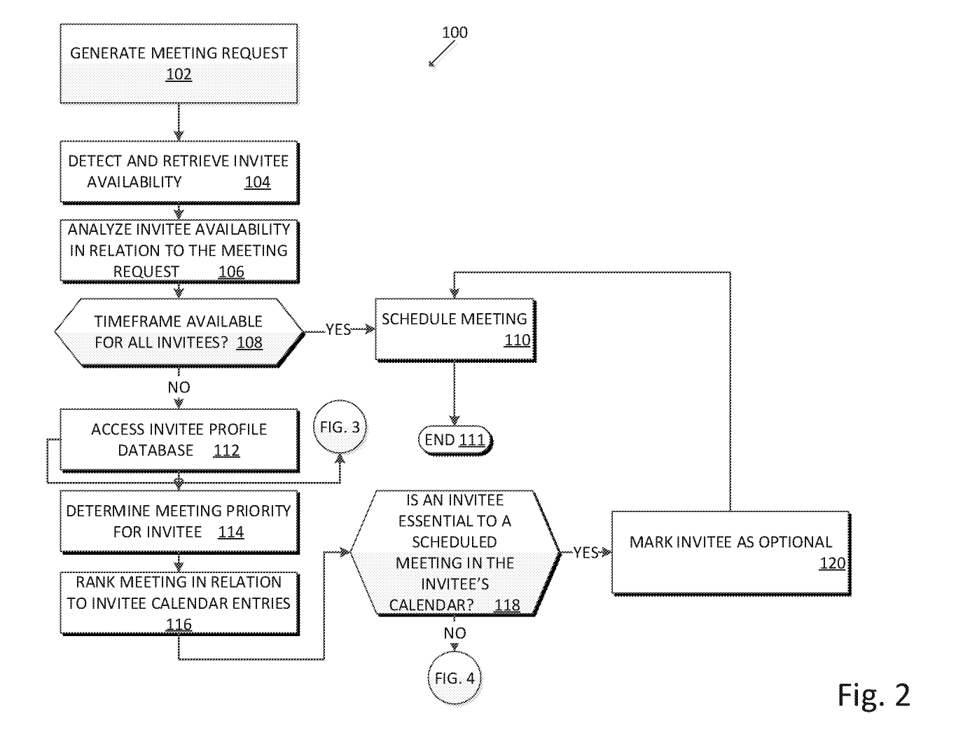

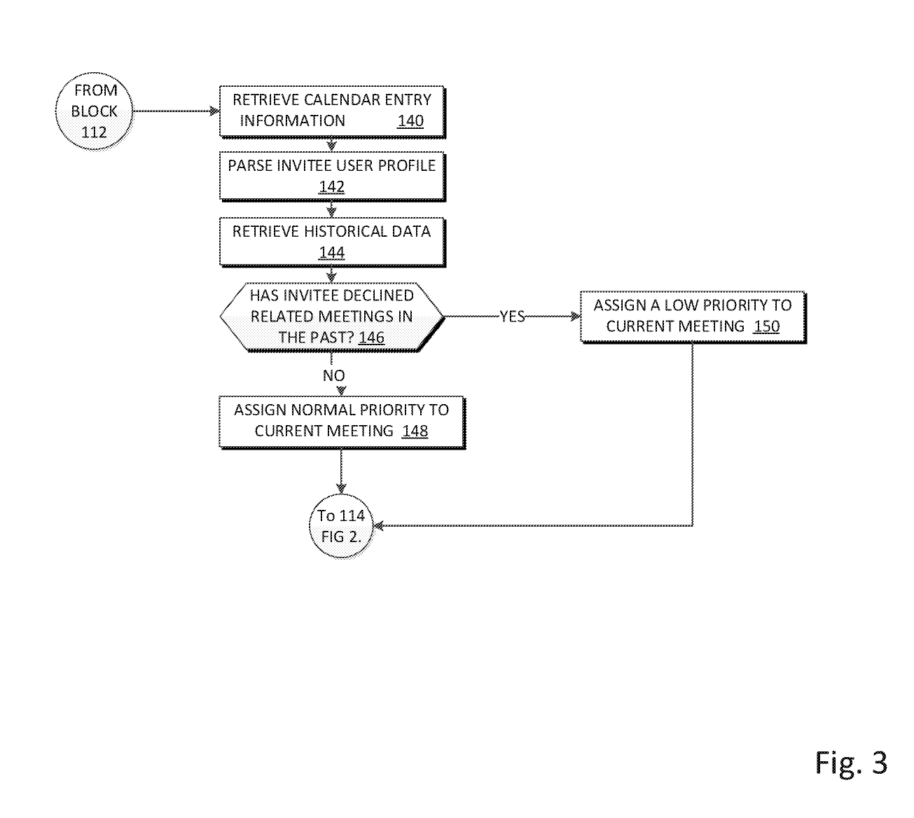

As will be discussed in more detail below, the cognitive analysis can mark invitees as optional or available based on a determination that a meeting request is a higher priority than an already scheduled meeting. The cognitive analysis uses a meeting description (provided by the meeting chairperson in the meeting request) to generate natural language comparison bits (N-grams). The cognitive analysis generates and compares N-grams (natural language comparison bits) to analyze calendar entries. Based on the cognitive analysis, calendar entries are prioritized and a meeting scheduled with the greatest number of available invitees. The determination of calendar priorities and the number of available invitees can also be referred to as “priorities and availability” when they are presented to the meeting chair. The meeting chair computing device 226 can be a laptop, tablet or any other computing device. The meeting chair computing device can be accessed at a first location. The invitee computing device can be a laptop, mobile device, tablet or any other computing device including the invention and can be accessed at a second location which can be remote with respect to the first location which includes the meeting chair computing device. The meeting chair computing device 226 and invitee computing device 228 can communicate over a communications network 220. Referring to FIGS. 2 and 3, more specifically, the method 100, can in one embodiment generate a meeting request 248 as in block 102, for scheduling a meeting. The generated meeting request can include a meeting description. The meeting description can include a number of agenda items for the meeting request. The meeting request is initiated by a meeting chairperson 230 (also referred to as meeting chair) using the meeting chair computing device 226 with the calendar application 270. The meeting request includes a plurality of invitees and a meeting description. The meeting request is deliverable to the plurality of invitees using the calendar application and the network 220 to schedule a meeting in response to the meeting request.

The invitees are generically depicted as user 234 in FIG. 1, and may include one or more invitees. Such invitees can be part of a group with common interests, or a plurality of invitees at the same company with a common business meeting, or from different companies. The method can determine conflicts if a common meeting day and time, i.e. a day of the week (month, day, and year) and a time of the day (e.g., a time slot) are not available for a plurality of invitees. As noted above, the invitees can include the meeting chair, and in one example, both the meeting chairperson and at least one invitee (or a plurality of invitees) could have a conflict of scheduled meetings resulting in a calendar conflict for scheduling a common meeting day and time for a meeting 250 initiated by the meeting request 248.

The method 100 detects and retrieves invitee availability as in block 104. The method detects an invitee's availability by detecting the invitee calendar application 270 and retrieving a list of calendar entries in the invitee's calendar application. At block 106 the method uses a cognitive analysis to analyze an invitee's availability to meet in relation to the meeting request 248 generated in block 102. The invitee availability can be ascertained by the cognitive analysis detecting free times and occupied times in the invitee's calendar, and comparing this information to the scheduled meeting.

The method can use a cognitive analysis to determine which invitees are available invitees with no calendar conflicts. Referring to block 108, the method can determine whether the initial time frame proposed by the meeting chair 230 is suitable. A time frame is suitable if all invitees 234 have the day and time on their respective calendars unallocated. For example, in a typical calendar an invitee can have time slots indicated as allocated/occupied (a scheduled meeting) or available (no scheduled meeting). The method can schedule a meeting as in block 110 and end as in block 111. If the meeting time does not suit all the invitees 234, the method accesses the invitee profile database as in block 112. The invitee profile database includes invitee profiles 240.

Referring to FIGS. 2 and 3, the method 100 determines the importance of the scheduled meeting using a cognitive analysis 242 of the invitees calendar entry (which can include calendar entry information), to retrieve calendar entry information, as in block 140. The method can determine the importance of the scheduled meeting in response to a calendar conflict. A calendar conflict can arise where there is no common meeting day and time between invitees, which in one example, can include the meeting chairperson. The method includes parsing an invitee profile 240 as in block 142. The meeting chair can also have profile data 238 (see FIG. 1). An invitee profile 240 can include historical data 264 (see FIG. 1) (which is retrieved at block 144) of one or more past related meetings to the meeting request. The method can perform a cognitive analysis as in block 146 to determine a priority of this scheduled meeting for the invitee. If the invitee has declined past meeting requests related to the current meeting, the method assigns a low priority to the current meeting as in block 150. If the invitee has not declined past meeting requests related to the current meeting, the method continues to block 148 and assigns a normal priority to the current meeting. The method continues to block 114 (in FIG. 2) to determine the importance of the scheduled meeting in an invitee's calendar in response to a calendar conflict between the meeting request and another scheduled meeting on the invitee's calendar.

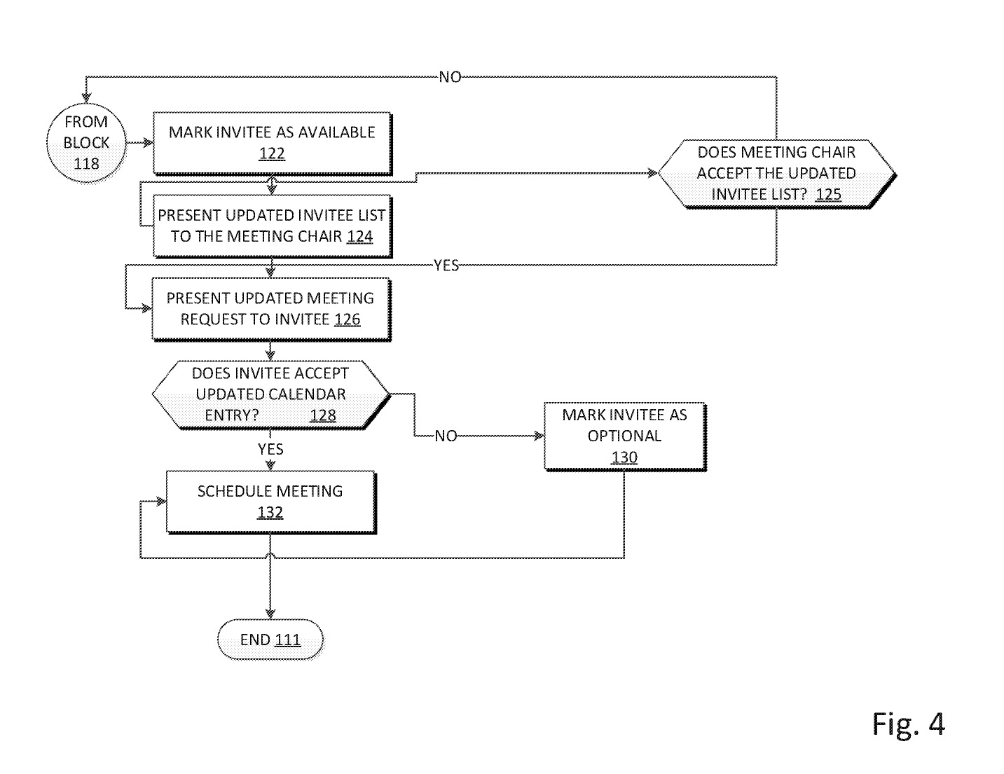

Referring to FIGS. 2 and 4, the meeting request is ranked in relation to invitee calendar entries, using a cognitive analysis 242 as in block 116. This ranking occurs when there is a conflict between the meeting request 248 and a scheduled meeting in the invitee's calendar as in block 108. The method determines an available invitee with a calendar conflict using a cognitive analysis of the invitee's calendar entry priorities as in block 118. If the method determines that the current meeting request is a higher priority than the invitee's other calendar entries, the invitee is marked as available at block 122. Thus, the method determines that an invitee 234 can be marked as available with a calendar conflict for the meeting request 248 as in block 122. The meeting chair 230 is presented with a list of available invitees as in block 124. The available invitees can share a common meeting day and time for a meeting initiated by the meeting request. In one example, as shown in FIG. 1, the meeting 250 is generated by the management module 224 after determining the available invitees, in response to a calendar conflict 249, as discussed above.

If the meeting chair does not accept the updated invitee list, the method reruns the cognitive analysis 242 as in block 118 to determine a new invitee list. If the meeting chair accepts the invitee list (at block 125), the updated meeting request 248 is presented and sent to the plurality of invitees 234 as in block 126. An available invitee is prompted to accept the updated meeting request as in 128. If an available invitee accepts the meeting request, the meeting is scheduled with the available invitee(s) as in block 132 and ends at block 111.

Referring to FIG. 4, in one embodiment, an invitee is marked as available as in block 122 or marked as an optional invitee as in block 130 upon declining the updated calendar entry at block 128. The meeting is scheduled at 132 with available invitees and the method ends 111.

Referring to FIGS. 2 and 4, the method includes determining an optional invitee with a higher priority calendar conflict using a cognitive analysis 242 as in block 118. The method continues as described previously referring to FIG. 2, and thereby in one instance of the disclosure, the invitee 234 is marked as optional at block 120. Once the method determines optional invitees, the meeting is scheduled by the method at block 110, and the method ends at block 111.

More specifically explaining determining optional invitees, referring to FIGS. 2 and 4, the method can mark an invitee with a calendar conflict 249 (at block 108) as optional as in block 120 based on the cognitive analysis determining that the invitee meets a threshold of importance to the meeting scheduled in the invitee's calendar (as in block 118) which has the calendar conflict. Here, the invitee is determined to be important or essential to the scheduled meeting in the invitee's calendar, and thus the invitee is designated as optional (at block 120) with respect to the meeting request 248. In one example, an available invitee can be marked as optional if the invitee is not important or essential to the scheduled meeting in the invitee's calendar, but declines to attend, as shown in blocks 128-130.

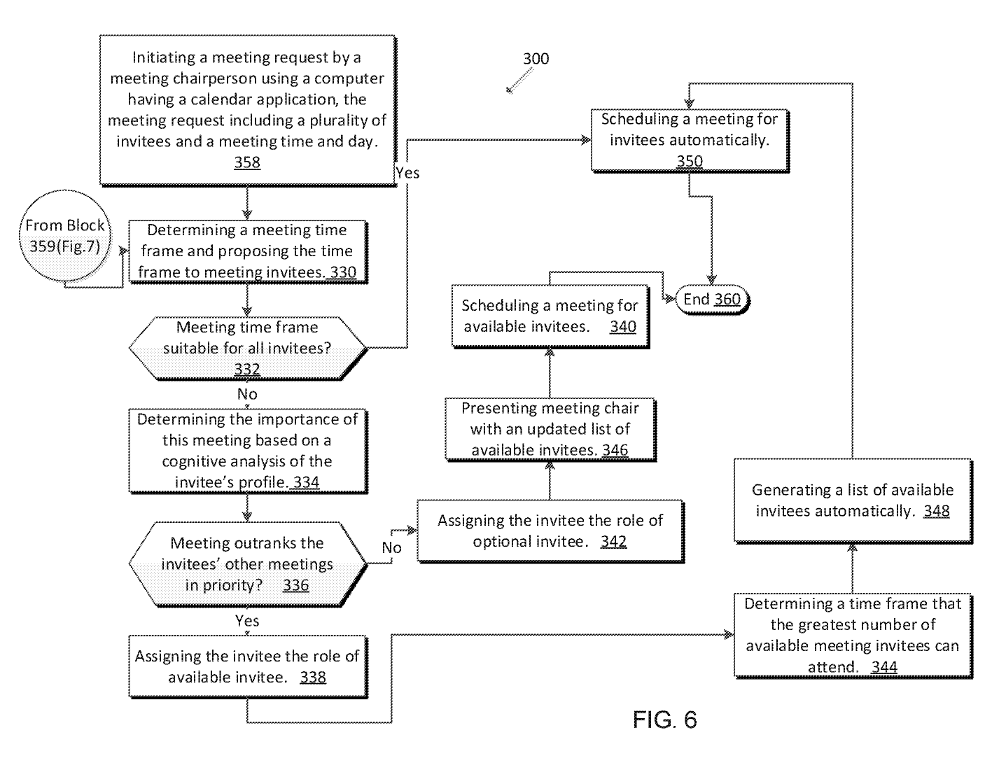

In another embodiment according to the invention, referring to FIG. 6, (which will be described in more detail later in this disclosure) the cognitive analysis can determine an importance of the meeting request description to the scheduled meeting in the invitee's calendar, in response to detecting the calendar conflict between the two meetings. The method uses a cognitive analysis 242 to mark an invitee as an optional invitee after determining that there is a calendar conflict 249 at block 332 (e.g., similarly as in block 108 shown in FIG. 2), and that the conflicting meeting in the calendar is more important than the meeting request 248 at block 336. This cognitive analysis is based on a determination that the meeting description in the scheduled meeting is more important than the meeting description in the meeting request. In this embodiment, a method 300 uses a cognitive analysis 242 to mark an invitee as an optional invitee after determining that there is a calendar conflict at block 332. In this scenario, an invitee can be designated as optional (at block 342) when the importance of the schedule meeting in the invitee's calendar meets or exceed a threshold of importance, that is, is determined to be more important than the meeting request (blocks 336-342). When the importance of the schedule meeting in the invitee's calendar does not meet or exceed the threshold of importance, that is, is determined to be less important than the meeting request (blocks 336-338), the invitee can be designated or assigned the role of attendee, or designated as available for the meeting of the meeting request, or designated as an available invitee.

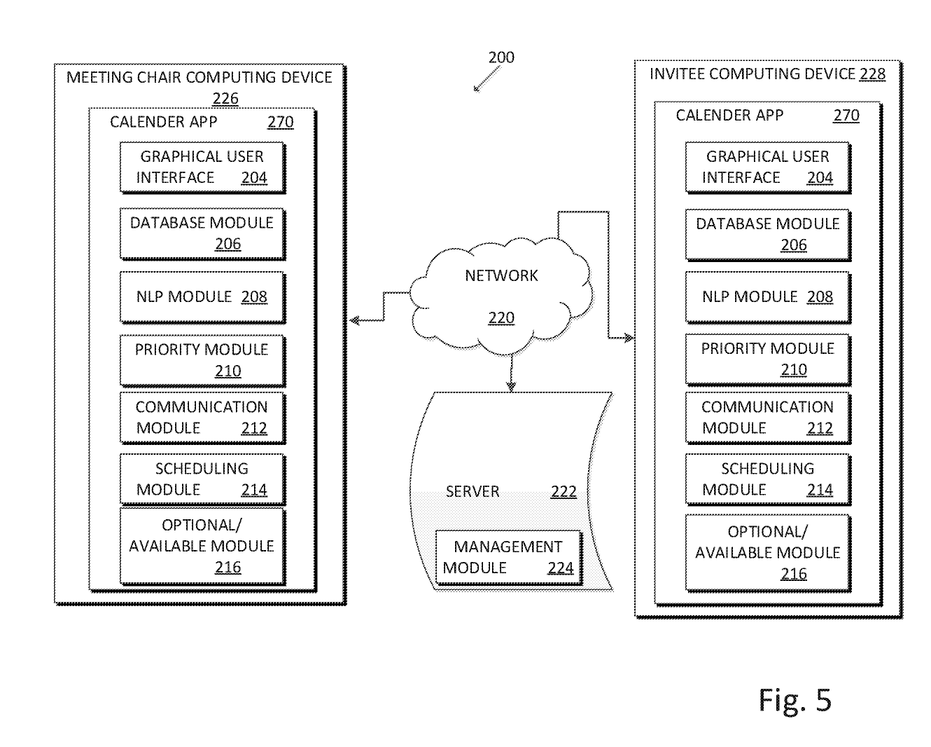

Referring to FIG. 5, an embodiment of the system, 200, is described. In one embodiment, a local client computer (or client computer) embodied as a meeting chair computer device 226, contains a calendar application 270. A second local computer (or client computer) embodied as an invitee computing device 228, also contains a calendar application 270. The calendar application includes a graphical user interface 204, a database module 206, a natural language processing module (also referred to as a NLP module) 208, a priority determination module 210, a communication module 212, a scheduling module 214 and an optional/available determination module 216. The database module 206 stores invitee information accessed by the cognitive analysis discussed above. The NLP module 208 generates the N-grams used by the cognitive analysis 242 (FIG. 1). The cognitive analysis N-grams are based on the meeting description contained in the meeting request 248 (FIG. 1). The priority determination module 210 can determine meeting priorities as discussed in FIG. 2 at block 118. The communication module 212 can send messages to the invitees and meeting chair related to the meeting request as in block 126. The scheduling module can schedule a meeting between available invitees as in block 110. The available/optional module can mark an invitee as available or optional as in block 120 or 122.

Referring to FIGS. 1 and 5, the meeting chair computer device 226 and invitee computing devices 228, are part of a networked connection 220. A central server 222 includes a management module 224 which manages the communications between the meeting chair computing device 226 and the invitee computing device 228 using the network 220. In one embodiment according to the present invention, the calendar applications 270 can be managed by the management module 224 located on the server 222, and the cognitive analysis 242, profiles 238, 240, and historical data 264 can be stored and accessed on the server 222. In one example, the management module can determine a calendar conflict 249 and a meeting 250. The server can be housed at a remote location 252. The management module can include a database (not shown) and in one embodiment interact with the calendar application 270 to determine available invitees as is described in the embodiments of the invention. The management module 224 can also be part of the calendar application and located on a remote server to the users to offer the method and system of the present invention as a service.

An embodiment of the invention incorporated in method 300 includes the cognitive analysis as depicted in FIG. 6, and includes some similar blocks in the flow chart as shown in FIG. 2, and refers to similar elements shown in FIG. 1 as does the method 100 shown in FIG. 2. However, the embodiment of the invention shown in FIG. 6 includes automatic features shown in blocks 348 and 350 as discussed below. Part of the method 300 was discussed above regarding the selection of optional invitees. The method 300 initiates a calendar meeting request from a computer, e.g., the meeting chair computing device 226 (see FIG. 1) using a computer networked environment 220 (FIG. 1) including the cognitive analysis 242 (FIG. 1) to determine meeting availability. Referring to block 358, the method 300 initiates a meeting request by the meeting chairperson 230 (FIG. 1) using a computer having a calendar application, the meeting request including a plurality of invitees and a meeting time and day.

The method includes determining a meeting time frame, i.e. one or more days and potential times, or a list of days and potential times, for the proposed meeting, and proposing the time frame to meeting invitees at block 330. For example, the method proposes a time frame that is suitable for all invitees using natural language processing to generate N-grams in order to analyze invitee calendar entries at block 332. The method can schedule a meeting for all invitees if there is an initial time frame that is suitable for all invitees as in block 340. The method then ends at 360. If there is no meeting time that is suitable for all invitees, the method begins determining the importance of the generated meeting based on the invitee's profile as in block 334.

As described above when distinguishing the determination of optional invitees in the method 100 shown in FIG., 2, in this alternative embodiment shown in FIG. 6, if the method 300 determines at 336 that the generated meeting is a higher priority than other meetings in the invitee's calendar, the method can mark the invitee as an available invitee at block 338. The method determines a time frame in which the greatest number of available invitees can attend a meeting at block 344. The method can automatically schedule the meeting at block 350 based on a list of available invitees automatically generated at block 348. The method then ends at 360. Alternatively, if the method determines that an invitee's other calendar entries are a higher priority than the current meeting, the invitee is marked optional at 342. The method can schedule the meeting for the other available invitees at 340 and end at 360.

In an embodiment of the invention, the method (see FIG. 4) generates an updated meeting request 248 in response to the meeting chair 230 rejecting the invitee list presented in block 125. The method then sends an updated meeting request 248 to available invitees and optional invitees, in response to the meeting chair 230 initiating the sending of the updated meeting request. In the same example, the available invitees can accept or decline the updated meeting request 248 as in block 128. If an invitee accepts the meeting request, the meeting is scheduled as in block 132 and the method ends as in block 111. If an available invitee declines the updated meeting request he is marked as optional as in block 130, the meeting is scheduled as in block 132 and the method ends as in block 111.

Referring to FIGS. 3 and 6, in one embodiment according to the present invention, the cognitive analysis labels an invitee 234 as available as in block 338 or an optional invitee at block 342 based on the cognitive analysis determining that the meeting request is a higher priority than an invitee's another scheduled meeting as in blocks 334, 336.

In one embodiment, the method retrieves calendar entry information as in block 140 from an invitee's profile as in block 142. The invitee profile includes the historical data 264 of the invitee's profile 240 (FIG. 1). The data 264 can include acceptance or rejection of at least one past related meeting as in block 146. The method presents calendar priorities and availability iteratively to the meeting chair for acceptance or rejection by the meeting chair 230 as in block 124.

Referring to FIGS. 2 and 6, in one embodiment, the method generates a list of invitees 234, having calendar conflicts at 108 using the cognitive analysis, and determining and indicating available invitees on the list of available invitees at 344. The method uses the cognitive analysis to determine invitees having a lower priority meeting than the request as in 118 and can indicate them as available as in 338. The method can also determine at 336 and indicate at 342 optional invitees having a higher priority meeting than the meeting request. The method can present said list of invitees to the meeting chair at 346.

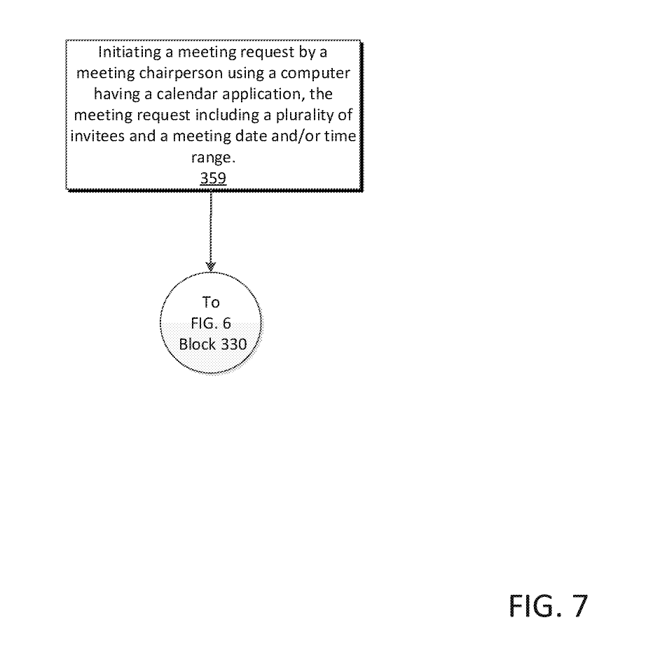

Referring to FIGS. 6 and 7, in one embodiment of the current invention, the meeting chairperson can initiate the meeting request 248 (FIG. 1) with a date and/or time range at block 359. The date and time range can be a target date and/or time slot on the calendar application in which the meeting chairperson is requesting to meet with the invitees. For example, the meeting chairperson may want to schedule the meeting for March 1^{st}, between 10:00 AM and 11:00 AM Eastern Standard Time. The method generates the meeting request and continues to block 330 to determine and propose the time range to invitees 234 (FIG. 1), as in block 330 (FIG. 6).

Thereby, the invention as discussed above in the embodiments, includes a method for scheduling a calendar meeting including initiating a meeting request by a meeting chairperson using a computer having a calendar application. The meeting request includes a meeting description and being deliverable to a plurality of invitees to schedule a meeting in response to the meeting request. The method includes determining an importance of a scheduled meeting in each of an invitees' calendars by using a cognitive analysis of the scheduled meeting in each of the invitees' calendars. It should be noted that the invention continuously learns the habits of the users and can update their historical profiles with respect to meeting acceptance/rejection, and organizational charts. This cognitive learning enables the invention to provide a meeting chair with updated information with respect to invitees.

The method determines the availability of the invitees in each of an invitee's calendar by comparing the importance of the scheduled meeting with the importance of existing meetings on the invitee's calendar. The meeting chair is presented with a list of the available invitees with the common meeting day and time for the meeting request. An optional invitee can be determined with the calendar conflict. The optional invitee is optional based on the determining of an importance which determines that the invitee meets a threshold of importance to the meeting. The meeting chair can also be presented with a list of available invitees with the common meeting day and time for the meeting request.

As discussed in detail above, according to the embodiments of the present invention, the method and system improves the efficiency of handling calendar invitations by, retrieving the meeting details data, augmenting the meeting details data with social data and analyzing the meeting details data in the meeting to determine the priority of the meeting invitation for each invitee. The method and system compare the meeting priority with the priority of all other meetings for each invitee and compares meeting conflicts to see if an invitee can be marked as available, that the meeting is scheduled with the greatest number of available invitees possible. The invention then attempts to schedule a meeting that the available invitees can attend. High priority invitees with meeting conflicts are marked as optional. According to the present invention, users can schedule meetings more effectively and efficiently.

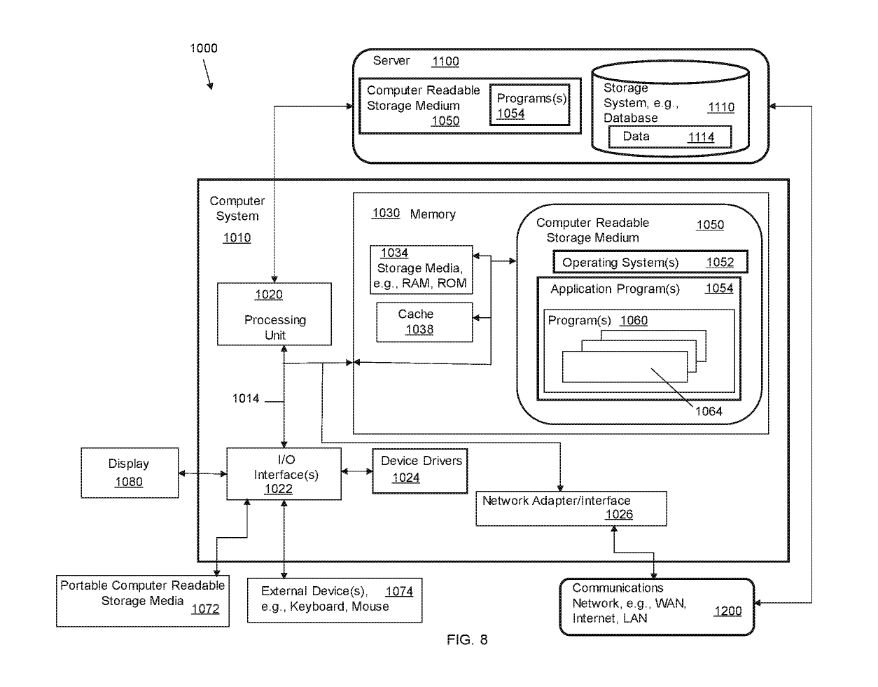

Referring to FIG. 8, a system 1000 includes a computer system or computer 1010 shown in the form of a generic computing device. The method 100, for example, may be embodied in a program(s) 1060 (FIG. 8) embodied on a computer readable storage device, for example, generally referred to as memory 1030 and more specifically, computer readable storage medium 1050 as shown in FIG. 8. For example, memory 1030 can include storage media 1034 such as RAM (Random Access Memory) or ROM (Read Only Memory), and cache memory 1038. The program 1060 is executable by the processing unit or processor 1020 of the computer system 1010 (to execute program steps, code, or program code). Additional data storage may also be embodied as a database 1110 which can include data 1114. The computer system 1010 and the program 1060 shown in FIG. 8 are generic representations of a computer and program that may be local to a user, or provided as a remote service (for example, as a cloud based service), and may be provided in further examples, using a website accessible using the communications network 1200 (e.g. interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in FIG. 8 as program modules 1064. The program 1060 and program modules 1064 can execute specific steps, routines, sub-routines, instructions or code, of the program.

The method of the present disclosure can be run locally on a device such as a mobile device, or can be run as a service, for instance, on the server 1100 which may be remote and can be accessed using the communications network 1200. The program or executable instructions may also be offered by a service provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

More specifically, as shown in FIG. 8, the system 1000 includes the computer system shown in the form of a general purpose computing device with illustrative periphery devices. The components of the computer system 1010 may include, but are not limited to, one or more processors or processing units 1020, a system memory 1030, and a bus 1014 that couples various system components including system memory 1030 to processor 1020.

The bus 1014 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media 1034 in the form of volatile memory, such as random access memory (RAM), and or/cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and a an optical disk drive for reading from or writing to a removable, non-volatile optical disk such as a CD-ROM, DVD-ROM, or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method 100 (FIG. 2), for example, may be embodied in one or more computer programs, generically referred to as a program(s) 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020.

The computer 1010 may also communicate with one or more external devices 1074 such as a keyboard, a pointing device, a display 1080, etc.; one or more devices that enable a user to interact with computer 1010; and/or any devices (e.g., network card, modem, etc.) that enables the computer 1010 to communicate with one or more computing devices. Such communication can occur via the Input/Output (I/O) interfaces 1022. Still yet, the computer 1010 can communicate with one or more networks 1200 such as local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, microwave transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later depicted.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g. mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g. cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

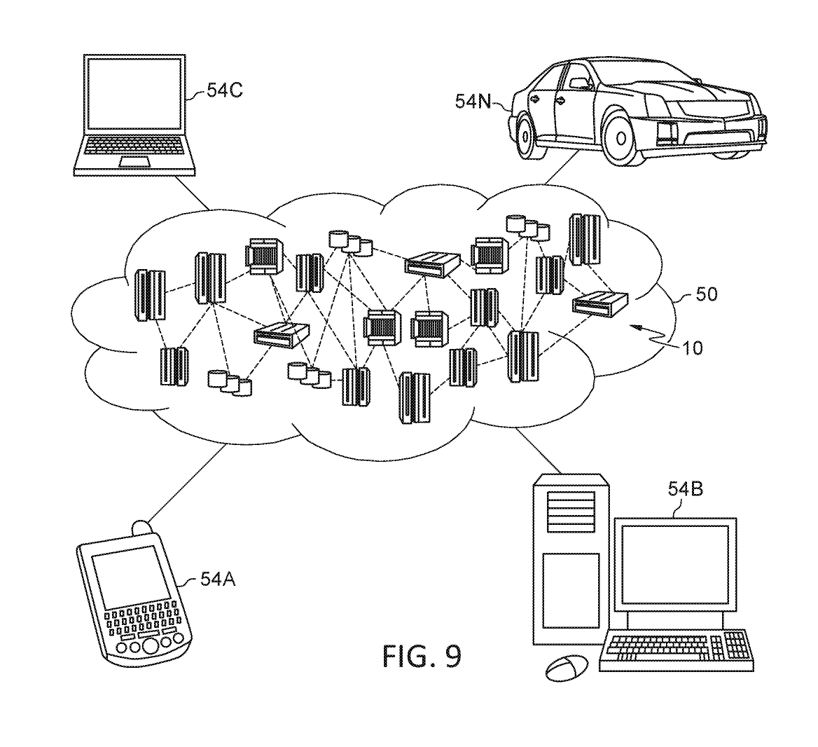

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid cloud as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

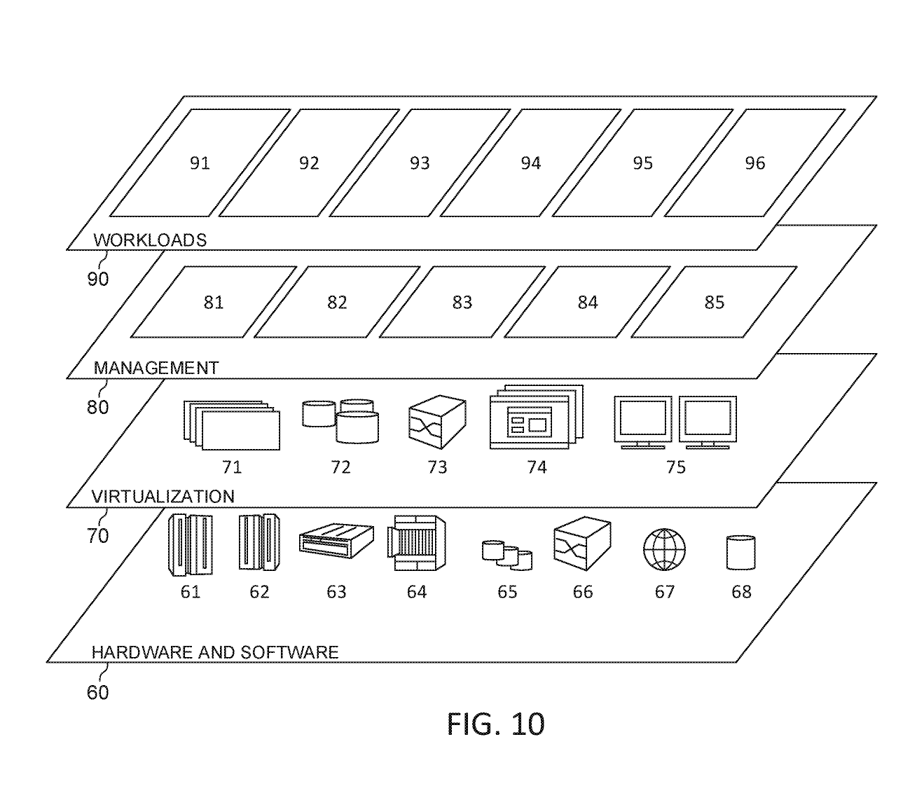

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61, RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73; including virtual private networks; virtual applications and operating systems 74; and virtual clients 75.

In one example management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and scheduling meetings using a cognitive analysis 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only (CD-ROM), a digital versatile disk (DVD), a memory stick, a floppy disk, a mechanically encoded device such as punch-cards or raised structures in a groove having instructions recorded thereon, and any suitable combination foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and party on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the function/acts specified in the flowchart and/or block diagram block or blocks. These computer readable program instructions may also be stored in a computer readable storage medium that can direct a computer, a programmable data processing apparatus, and/or other devise to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the function/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the function noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for automatically scheduling a calendar meeting, comprising:
initiating a meeting request by a meeting chairperson using a first computer having a calendar application, the meeting request including a meeting description, the meeting description including a number of agenda items for the meeting request, and the meeting request being deliverable to a plurality of invitees using one or more respective computers each having a calendar application, wherein the one or more computers are connected by a communications network, the plurality of invitees being selected from the group consisting of: group members with common interests, invitees at a same company, or invitees from a different company, to schedule a meeting in response to the meeting request;
detecting and retrieving availability of the invitees by determining a calendar availability for each of the invitees, the calendar availability being a list of calendar entries in the invitees calendar application;
analyzing the availability of the invitees in relation to the meeting request to determine an available invitee with no calendar conflicts, a calendar conflict being defined as an occurrence of a noncommon meeting day and time between the invitees based on the scheduled meetings in their respective calendars;
determining an importance of a scheduled meeting in each of an invitees' calendars in response to a calendar conflict for scheduling a common meeting day and time between the invitees for the meeting based on the scheduled meetings in each of the invitees' calendars, the importance being determined using a cognitive analysis of the scheduled meeting in each of the invitees' calendars, the cognitive analysis using natural language comparison bits to analyze calendar entries, the cognitive analysis including the meeting description, invitee scheduled meeting information, and a profile of each of the invitees which includes historical data of a past related meeting to the meeting request, wherein the cognitive analysis prioritizes the analyzed calendar entries;
determining one or more available invitees with the calendar conflict based on the analyzing of the availability of the invitees, and the determining of an importance of the scheduled meeting using the cognitive analysis, the cognitive analysis determining the importance of the scheduled meeting based on a comparison of the priority of the meeting request to the scheduled meetings of each the invitees, such that a meeting is scheduled with a greatest number of available invitees possible, wherein the meeting description of the meeting request is more important than the meeting description of the scheduled meeting of the available invitee with the calendar conflict;
determining, using the cognitive analysis, when an invitee of the invitees meets a threshold of importance to the meeting of the meeting request;
designating the invitee as an available invitee or attendee, when the importance of the scheduled meeting in the invitee's calendar does not meet or exceed the threshold of importance of the meeting of the meeting request; designating, using the cognitive analysis, the invitee as an unavailable invitee or optional, when the importance of the scheduled meeting in the invitee's calendar meets or exceeds the threshold of importance of the meeting of the meeting request;
presenting the meeting chair with a list of the available invitees with the common meeting day and time for the meeting request, based on the cognitive analysis determining the greatest number of available invitees possible; and
monitoring the invitee's profile and iteratively updating the invitee's profile based on the invitee accepting or rejecting an incoming meeting request.
